(19) United States
(12) Patent Application Publication
(10) Pub. No.: US 2023/0337681 A1
(43) Pub. Date: Oct. 26, 2023

(54) MICROBIAL INOCULANT FORMULATIONS

(71) Applicant: NewLeaf Symbiotics, Inc., St. Louis, MO (US)

(72) Inventors: John T. Whitteck, Olivette, MO (US); Michael E. Frodyma, St. Louis, MO (US); Aaron S. Kelley, Town & Country, MO (US)

(21) Appl. No.: 18/004,937

(22) PCT Filed: Jul. 9, 2021
(86) PCT No.: PCT/US2021/041118

§ 371 Date: Jan. 10, 2023

Related U.S. Application Data
(60) Provisional application No. 63/050,686, filed on Jul. 10, 2020.

(51) Int. Cl. A01N 63/20; A01N 25/04

(52) U.S. Cl. CPC A01N 63/20; A01N 25/04

(57) ABSTRACT

Provided herein are various microbial inoculant compositions, methods for preparing these compositions, and methods of using such compositions for treatment of plants.

### CROSS-REFERENCE TO RELATED APPLICATIONS

This international patent application claims the benefit of U.S. Provisional Pat. Application No. 63/050,686, filed Jul. 10, 2020, the entire disclosure of which is incorporated herein by reference.

### TECHNICAL FIELD

This disclosure relates to non-aqueous liquid compositions comprising agricultural microbial inoculants, methods of using such compositions for production of emulsions comprising the microbial inoculants and agricultural chemicals and use of the non-aqueous liquid and/or emulsion compositions comprising agricultural inoculants for treatment of plants.

### BACKGROUND

Microbial inoculants have been discovered which improve crop production, for example by improving plant growth, and development, by enhancing yield and/or quality of harvested plants and/or plant parts, and/or by providing protection against plant pathogens. Such beneficial microbes are finding increased use in agricultural applications. For ease of application to crops, it is desirable to mix such microbes with agricultural chemicals, for example as tank mixes, to avoid multiple treatments that add time and expense to plant production. Formulations for plant application of some inoculants have been developed, and additional formulations are needed.

### SUMMARY

The present disclosure provides liquid microbial inoculant compositions, where the microbial inoculants are dispersed as dried powders or particulates into a non-aqueous continuous phase comprising a non-aqueous solvent (e.g., a water-immiscible solvent). In some embodiments, the microbial inoculant is homogeneously dispersed into the non-aqueous continuous phase. Such compositions comprise additional components to enhance mixing of the microbial inoculants with aqueous compositions comprising agricultural chemicals and/or to enhance the stability of microbial inoculants in such aqueous compositions. In certain embodiments, the microbial inoculant is aMethylobacterium strain or combination of two or more Methylobacterium strains. Further disclosed are compositions comprising an emulsion which comprises the dispersed microbial compositions and an aqueous phase comprising one or more agricultural chemicals. In such compositions, stability of the microbial inoculants is enhanced by physical separation of the microbial powder or particulates from the agricultural chemicals present in the aqueous phase. Such compositions also provide enhanced properties that facilitate application of the microbial inoculants to seeds, or other methods used to provide microbial inoculants to plants, including for example deposition in furrow, application to a growth medium in which a plant will be grown, and application by foliar spray.

In one embodiment, a microbial inoculant composition comprises i) a non-aqueous liquid continuous phase comprising a non-aqueous solvent (e.g., a water-immiscible solvent), wherein the non-aqueous solvent (e.g., water-immiscible solvent) comprises from about 15% to about 98.8% percent of the total composition by weight; ii) a rheology modifier comprising from about 0.1% to about 5% percent of the total composition by weight; iii) at least one emulsifier comprising from about 0.1% to about 20% percent of the total composition by weight; and iv) at least one agricultural microbial inoculant dispersed in said non-aqueous liquid continuous phase, wherein said agricultural inoculant comprises from about 1% to about 60% percent of the total composition by weight. In certain embodiments, the agricultural microbial inoculant is homogeneously dispersed in the non-aqueous liquid continuous phase. In some embodiments, the agricultural inoculant comprises one or more isolates of Methylobacterium.

In certain embodiments, the non-aqueous continuous phase comprises an esterified plant oil. In certain embodiments, the esterified plant oil is a methyl plant seed oil. In certain embodiments, the rheology modifier comprises a hydrophobic silica or an organoclay. In certain embodiments, the emulsifier comprises a seed oil ethoxylate and/or an ethoxylated sorbitan fatty ester. In certain embodiments, the agricultural inoculant comprises one or more isolates of Methylobacterium. In one embodiment, the compositions comprise i) an esterified plant oil, wherein said esterified plant oil comprises from about 15% to about 98.8% percent of the total composition; ii) a hydrophobic silica or organoclay rheology modifier comprising from about 0.1% to about 5% percent of the total composition; iii) at least one emulsifier comprising from about 0.1% to about 20% percent of the total composition; and iv) at least one Methylobacterium isolate, dispersed in said non-aqueous continuous phase comprising an esterified plant oil, wherein said Methylobacterium isolate comprises from about 1% to about 60% percent of the total composition. In certain embodiments, the Methylobacterium is one or more Methylobacterium isolates selected from ISO04, deposited as NRRL B-50932, ISO10, deposited as NRRL B-50938, and ISO20, deposited as NRRL B-67743.

In further embodiments, compositions are emulsions comprising any of the non-aqueous liquid compositions with dispersed microbial inoculants described herein and an aqueous phase comprising one or more agricultural chemicals. Such agricultural chemicals include fertilizers, pesticides, herbicides, and combinations thereof.

Also provided herein are methods of making stable liquid microbial inoculant compositions. In one embodiment, a non-aqueous liquid composition is prepared by combining a non-aqueous solvent (e.g., a water-immiscible solvent) with one or more rheology modifiers and one or more surfactants, and a dried inoculant composition is dispersed into said non-aqueous liquid composition to produce an emulsifiable inoculant composition. In certain embodiments, the non-aqueous liquid microbial composition produced by such methods comprises i) a non-aqueous liquid continuous phase, wherein the non-aqueous liquid comprises a non-aqueous solvent (e.g., a water-immiscible solvent) comprising from about 15% to about 98.8% percent of the total composition by weight; ii) a rheology modifier comprising from about 0.1% to about 5% percent of the total composition by weight; iii) at least one emulsifier comprising from about 0.1% to about 20% percent of the total composition by weight; and iv) at least one agricultural microbial inoculant, wherein said agricultural inoculant comprises from about 1% to about 60% percent of the total composition by weight. In certain embodiments, the non-aqueous solvent (e.g., water-immiscible solvent) is an esterified plant seed oil. In some embodiments, the agricultural inoculant comprises one or more isolates of Methylobacterium. In certain embodiments, the methods further comprise the step of incorporating the emulsifiable inoculant composition into an aqueous composition comprising at least one agricultural chemical, whereby an emulsion comprising dispersed microbial inoculant in a water-immiscible phase and an aqueous continuous phase comprising at least one agricultural chemical is produced.

Also provided herein are plants or plant parts coated with any of the liquid microbial inoculant compositions provided herein.

In further embodiments, methods of treating a plant, plant part, or soil or nutrient medium where a plant is grown with liquid microbial inoculant compositions provided herein are provided. In certain embodiments, a plant part is a seed.

### DETAILED DESCRIPTION

### Definitions

The term “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

Where a term is provided in the singular, embodiments comprising the plural of that term are also provided.

As used herein, the terms “include,” “includes,” and “including” are to be construed as at least having the features or encompassing the items to which they refer while not excluding any additional unspecified features or unspecified items.

As used herein, the phrases “adhered thereto” and “adherent” refer to Methylobacterium that are associated with a solid substance by growing, or having been grown, on a solid substance.

As used herein, the term “biological” refers to a component of a composition for treatment of plants or plant parts comprised of or derived from a microorganism. Biologicals include biocontrol agents, other beneficial microorganisms, microbial extracts, natural products, plant growth activators or plant defense agents. Non-limiting examples of biocontrol agents include bacteria, fungi, beneficial nematodes, and viruses.

As used herein, the phrase “agriculturally acceptable adjuvant” refers to a substance that enhances the performance of a biological or pesticide in a composition for treatment of plants and/or plant parts. In certain compositions, a biological can comprise one or more Methylobacterium isolates.

As used herein, the phrase “agriculturally acceptable excipient” refers to an essentially inert substance that can be used as a diluent and/or carrier for a biological or pesticide in a composition for treatment of plants and/or plant parts.

As used herein, the term “strain” shall include all isolates of such strain.

As used herein, the phrase “contaminating microorganism” refers to microorganisms in a composition that was not identified and intentionally introduced into the composition.

As used herein, “variant” when used in the context of a Methylobacterium isolate, refers to any isolate that has chromosomal genomic DNA with at least 99%, 99.9%, 99.8%, 99.7%, 99.6%, or 99.5% sequence identity to chromosomal genomic DNA of a deposited Methylobacterium isolate provided herein. A variant of an isolate can be obtained from various sources including soil, plants or plant material, and water, particularly water associated with plants and/or agriculture. Variants include derivatives obtained from deposited isolates. Methylobacterium isolates or strains can be sequenced (for example as taught by Sanger et al. (1977), Bentley et al. (2008) or Caporaso et al. (2012)) and genome-scale comparison of the sequences conducted (Konstantinos et al. (2005)) using sequence analysis tools (for example, BLAST, as taught by Altschul et al. (1990)).

As used herein, “derivative” when used in the context of a Methylobacterium isolate, refers to any Methylobacterium that is obtained from a deposited Methylobacterium isolate provided herein. Derivatives of a Methylobacterium isolate include, but are not limited to, derivatives obtained by selection, derivatives selected by mutagenesis and selection, and genetically transformed Methylobacterium obtained from a Methylobacterium isolate. A “derivative” can be identified, for example based on genetic identity to the strain or isolate from which it was obtained and will generally exhibit chromosomal genomic DNA with at least 99%, 99.9%, 99.8%, 99.7%, 99.6%, or 99.5% sequence identity to chromosomal genomic DNA of the strain or isolate from which it was derived.

As used herein, the term “emulsion” refers to a colloidal mixture of two immiscible liquids wherein one liquid is the continuous phase and the other liquid is the dispersed phase. In certain embodiments, the continuous phase is an aqueous liquid comprising one or more agricultural chemicals, and the dispersed phase is a liquid that is not miscible or only partially miscible in the aqueous liquid and comprises one or more agricultural inoculants dispersed therein.

The “non-aqueous solvent,” as noted herein, can have a miscibility in water that is equal to or less than that of n-pentanol at 25° C. The non-aqueous solvent can be a water-immiscible solvent. A water-immiscible solvent includes solvents that do not form a homogenous mixture when mixed with water. The solubility of the water-immiscible solvent at 25° C. can be less than 1 g/L, less than 0.1 g/L, less than 0.01 g/L, or even effectively zero.

As used herein an “esterified plant oil” refers to the fatty acid esters or fatty acid ester mixture resulting from transesterification of a plant oil by reaction with an alcohol and may also be used to refer to a synthetic fatty acid ester product where the synthetic esters have limited water solubility.

As used herein, “dried” in reference to a microbial inoculant preparation, for example a dried powder or dried particulates, refers to a microbial composition with a low moisture content following preparation, for example, by spray drying, freeze drying, air drying, fluid bed drying, electrospray drying, or other drying methods.

As used herein, an “emulsifier” is a surfactant that assists in formation and stability of an emulsion when mixing two immiscible or partially miscible liquids.

As used herein, the phrase “essentially free of contaminating microorganisms” refers to a composition where at least about 95% of the microorganisms present by amount or type in the composition are the desired Methylobacterium or other desired microorganisms of predetermined identity.

As used herein, the term “heterologous”, when used in the context of Methylobacterium that at least partially coats a plant or plant part, refers to a Methylobacterium that is not naturally associated with a plant or plant part of the same species as the plant or plant part that is at least partially coated with the Methylobacterium. In certain embodiments, the heterologous Methylobacterium that is used to at least partially coat a plant or plant part of a first plant species is a Methylobacterium that was isolated from a second and distinct plant species.

As used herein, an “agricultural chemical” refers to a chemical fertilizer, pesticide or herbicide.

As used herein, a “pesticide” refers to an insecticide, fungicide, nematocide, bacteriocide, or any combination thereof.

As used herein, a “microbial inoculant” is a beneficial bacterial or fungal strain that promotes plant health. Benefits of application of various microbial inoculants include increased plant growth, and development, enhanced yield and/or quality of harvested plants and/or plant parts, and/or protection against plant pests and pathogens.

As used herein, the term “Methylobacterium” refers to genera and species in the Methylobacteriaceae family, including bacterial species in the Methylobacterium genus and proposed Methylorubrum genus (Green and Ardley (2018)). Methylobacterium includes pink-pigmented facultative methylotrophic bacteria (PPFM) and also encompasses the non-pink-pigmented Methylobacterium nodulans, as well as colorless mutants of Methylobacterium isolates. For example, and not by way of limitation, “Methylobacterium” refers to bacteria of the species listed below as well as any new Methylobacterium species that have not yet been reported or described that can be characterized as Methylobacterium or Methylorubrum based on phylogenetic analysis: Methylobacterium adhaesivum; Methylobacterium oryzae; Methylobacterium aerolatum; Methylobacterium oxalidis; Methylobacterium aquaticum; Methylobacterium persicinum; Methylobacterium brachiatum; Methylobacterium phyllosphaerae; Methylobacterium brachythecii; Methylobacterium phyllostachyos; Methylobacterium bullatum; Methylobacterium platani; Methylobacterium cerastii; Methylobacterium pseudosasicola; Methylobacterium currus; Methylobacterium radiotolerans; Methylobacterium dankookense; Methylobacterium soli; Methylobacterium frigidaeris; Methylobacterium specialis; Methylobacterium fujisawaense; Methylobacterium tardum; Methylobacterium gnaphalii; Methylobacterium tarhaniae; Methylobacterium goesingense; Methylobacterium thuringiense; Methylobacterium gossipiicola; Methylobacterium trifolii; Methylobacterium gregans; Methylobacterium variabile; Methylobacterium haplocladii; Methylobacterium aminovorans (Methylorubrum aminovorans); Methylobacterium hispanicum; Methylobacterium extorquens (Methylorubrum extorquens); Methylobacterium indicum; Methylobacterium podarium (Methylorubrum podarium); Methylobacterium iners; Methylobacterium populi (Methylorubrum populi); Methylobacterium isbiliense; Methylobacterium pseudosasae (Methylorubrum pseudosasae); Methylobacterium jeotgali; Methylobacterium rhodesianum (Methylorubrum rhodesianum); Methylobacterium komagatae; Methylobacterium rhodinum (Methylorubrum rhodinum); Methylobacterium longum; Methylobacterium salsuginis (Methylorubrum salsuginis); Methylobacterium marchantiae; Methylobacterium suomiense (Methylorubrum suomiense; Methylobacterium mesophilicum; Methylobacterium thiocyanatum (Methylorubrum thiocyanatum); Methylobacterium nodulans; Methylobacterium zatmanii (Methylorubrum zatmanii); Methylobacterium organophilum.

To the extent to which any of the preceding definitions is inconsistent with definitions provided in any patent or non-patent reference incorporated herein by reference, any patent or non-patent reference cited herein, or in any patent or non-patent reference found elsewhere, it is understood that the preceding definition will be used herein.

### Dispersed Microbial Inoculant Compositions

Provided herein are liquid microbial inoculant compositions, where the microbial inoculants are dispersed as dried powders or particulates into a non-aqueous solvent (e.g., a water-immiscible solvent) which forms a non-aqueous continuous phase. Such compositions can be applied to plants or plant parts, or to soil or nutrient media where a plant is grown. Such compositions comprise additional components to facilitate incorporation of the microbial inoculants into tank mixes for agricultural application, including one or more rheology modifiers and one or more emulsifiers. Upon addition to a tank comprising one or more agricultural chemicals, the non-aqueous continuous phase comprising dispersed microbial inoculant is spontaneously emulsified, and the dispersed microbial inoculant is incorporated into the aqueous composition. By using such dispersed inoculant compositions for mixing with an agricultural tank mixes comprising an aqueous phase with one or more agricultural chemicals, a pre-slurry step to mix dried inoculants with water is unnecessary and the problem of clogged lines and/or nozzles is avoided.

Microbial inoculant compositions provided herein comprise i) a non-aqueous liquid continuous phase comprising a non-aqueous solvent (e.g., a water-immiscible solvent), wherein the non-aqueous solvent (e.g., water-immiscible solvent) comprises from about 15% to about 98.8% percent of the total composition by weight; ii) a rheology modifier comprising from about 0.1% to about 5% percent of the total composition by weight; iii) at least one emulsifier comprising from about 0.1% to about 20% percent of the total composition by weight; and iv) at least one agricultural microbial inoculant, wherein said agricultural inoculant comprises from about 1% to about 60% percent of the total composition by weight.

In some embodiments, the non-aqueous solvent (e.g., water-immiscible solvent) is a plant seed oil or an esterified plant seed oil. Useful esterified plant seed oils include methyl and ethyl oils, including methyl or ethyl esters of soybean oil. Esterified plant seed oils from other plants, including, but not limited to corn, canola, sunflower, safflower, flax, castor, coconut, cotton, jojoba and sesame are also find use in the disclosed microbial inoculant compositions. In a similar manner, synthetic preparations of fatty acid esters of C8 - C18 have limited solubility in water and may be used in the microbial inoculant compositions provided here, as well as various combinations of plant seed oils, esterified plant seed oils, and synthetic C8-C18 esters. In some embodiments, the non-aqueous solvent (e.g., water-immiscible solvent) is methyl soybean oil. The non-aqueous solvent (e.g., water-immiscible solvent) phase comprises from about 15% to about 98.8% percent by weight of the total composition. In some embodiments, the non-aqueous solvent (e.g., water-immiscible solvent) comprises from about 18% to about 95% percent of the total composition. In some embodiments, the non-aqueous solvent (e.g., water-immiscible solvent) comprises from about 20% to about 90% percent of the total composition. In some embodiments, the non-aqueous solvent (e.g., water-immiscible solvent) comprises from about 25% to about 85% percent of the total composition. In some embodiments, the non-aqueous solvent (e.g., water-immiscible solvent) comprises from about 30% to about 80% percent of the total composition. In some embodiments, the non-aqueous solvent (e.g., water-immiscible solvent) comprises from about 40% to about 75% percent of the total composition. In some embodiments, the non-aqueous solvent (e.g., water-immiscible solvent) comprises about 40%, about 50%, about 60%, about 70%, about 75%, about 80%, about 90% or about 95% of the total composition.

One or more rheology modifiers is present in the disclosed compositions. The rheology modifier adds stability to compositions comprising dispersed inoculant in non-aqueous solvent (e.g., water-immiscible solvent) by increasing the viscosity of the compositions, ensuring flowability, and preventing sedimentation of the microbial inoculant that is dispersed in the solvent. Rheology modifiers useful in the disclosed compositions include silicas, such as silicon dioxide, clays, oils, waxes, polymers, trihydroxystearin and other thickeners known to stabilize oil dispersion compositions. In some embodiments, where the non-aqueous solvent (e.g., water-immiscible solvent) is an esterified plant oil, the rheology modifier comprises a hydrophobic silica or an organoclay. The rheology modifier comprises from about 0.1% to about 5% percent of the total composition by weight. In some embodiments, the rheology modifier comprises from about 0.5% to about 2% percent of the total composition by weight. In some embodiments, the rheology modifier comprises from about 1% to about 3% percent of the total composition by weight. In some embodiments, the rheology modifier comprises about 0.1%, about 0.3%, about 0.5%, about 1%, about 1.5%, about 2%, about 2.5%, about 3%, about 3.5%, about 4%, about 4.5%, or about 5%, of the total composition by weight. In some embodiments, the rheology modifier is a hydrophobic fumed silica and comprises about 1.5% of the total composition by weight. In some embodiments, a rheology modifier may be dispersed in a non-aqueous solvent (e.g., a water-immiscible solvent) prior to addition to the microbial inoculant composition. In some embodiments, the rheology modifier is mixed with the same non-aqueous solvent (e.g., water-immiscible solvent) as used for the continuous phase of the composition. Such pre-mixing may be useful for even distribution and increased stabilization properties of the rheology modifier. Furthermore, a combination of one or more different rheology modifiers can be used in the disclosed compositions. In addition to the rheology modifiers for use in oil-based compositions, rheology modifiers for stabilizing an emulsion in an aqueous composition (stabilizers) can also be used in the compositions. Such aqueous rheology modifiers or stabilizers may assist in stabilization of emulsions formed by addition of the compositions comprising dispersed inoculant in non-aqueous solvent (e.g., water-immiscible solvent) to aqueous compositions comprising one or more agricultural chemicals. Non-limiting examples of such aqueous rheology modifiers include gums, such as xanthan gum or diutan gum. Such aqueous rheology modifiers may be present at less than 1% of the compositions comprising dispersed inoculant in a non-aqueous solvent (e.g., a water-immiscible solvent). In some embodiments, rheology modifiers or stabilizers, may be dispersed in a non-aqueous solvent (e.g., a water-immiscible solvent) before preparation of the microbial inoculant composition. Such pre-mixing may be useful for even distribution and increased stabilization properties of the rheology modifier or stabilizer.

One or more emulsifiers is present in the disclosed microbial inoculant compositions that assists in formation and stabilization of an emulsion when mixing the disclosed compositions comprising microbial inoculant dispersed in a non-aqueous solvent (e.g., a water-immiscible solvent), with aqueous mixtures comprising one or more agricultural chemicals. Various emulsifiers that find use in agricultural applications may be used in the present compositions, including, but not limited to castor oil ethoxylate (such as Toximul 8240), soy oil ethoxylates, ethoxylated sorbitan fatty esters (such as Tween 80), fatty alcohol ethoxylates and various other ethoxylates, amphoteric polymer based surfactants (such as Atlox 4915), and various combinations of these and/or other emulsifiers. Emulsifiers comprise from about 0.1% to about 20% of the total composition by weight of the disclosed emulsifiable compositions. In some embodiments, one or more emulsifiers are used and comprise from about 1% to about 20% of the total composition by weight. In some embodiments, one or more emulsifiers are used and comprise from about 2% to about 18% of the total composition by weight. In some embodiments, one or more emulsifiers are used and comprise from about 3% to about 15% of the total composition by weight. In some embodiments, one or more emulsifiers are used and comprise from about 4% to about 12% of the total composition by weight. In some embodiments, one or more emulsifiers are used and comprise from about 5% to about 10% of the total composition by weight. In some embodiments, one or more emulsifiers are used and comprise from about 6% to about 8% of the total composition by weight. In some embodiments, an emulsifier in the disclosed composition is an ethoxylated sorbitan fatty ester and comprises from about 0.1% to about 2% of the total composition by weight. In some embodiments, an ethoxylated sorbitan fatty ester comprises from about 0.5% to about 1% of the total composition by weight and a second emulsifier comprises from about 4% to about 8% of the total composition by weight.

Microbial inoculants in the compositions provided herein can be bacterial or fungal inoculants and provide improvements to plant production in a number of ways, for example by improving plant growth and development, by enhancing yield and/or quality of harvested plants and/or plant parts, and/or by providing protection against plant pathogens. In some embodiments, a microbial inoculant in a composition provided herein is a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comomonas, Corynebacterium, Curtobacterium, Enterobacter, Flavobacterium, Gluconobacter, Hydrogenophage, Klebsiella, Methylobacterium, Paenibacillus, Pasteuria, Phingobacterium, Photorhabdus, Phyllobacterium, Pseudomonas, Rhizobium, Bradyrhizobium, Serratia, Stenotrophomonas, Variovorax, and Xenorhadbus, or a fungus of the genus Alternaria, Ampelomyces, Aspergillus, Aureobasidium, Beauveria, Colletotrichum, Coniothyrium, Gliocladium, Metarhisium, Muscodor, Paecilonyces, Trichoderma, Typhula, Ulocladium, and Verticilium. In particular embodiments, a microbial inoculant in the compositions is one or more Methylobacterium isolates. In certain embodiments, a microbial inoculant is a Methylobacterium isolate disclosed in Table 1, or variant thereof.

TABLE 1

Methylobacterium isolates

| | | |
|---|---|---|
| ISOLATE No. | USDA ARS NRRL No.¹ | Deposit Date |
| ISO01 | NRRL B-50929 | Mar. 12, 2014 |
| ISO02 | NRRL B-50930 | Mar. 12, 2014 |
| ISO03 | NRRL B-50931 | Mar. 12, 2014 |
| ISO04 | NRRL B-50932 | Mar. 12, 2014 |
| ISO05 | NRRL B-50933 | Mar. 12, 2014 |
| ISO06 | NRRL B-50934 | Mar. 12, 2014 |
| ISO07 | NRRL B-50935 | Mar. 12, 2014 |
| ISO08 | NRRL B-50936 | Mar. 12, 2014 |
| ISO09 | NRRL B-50937 | Mar. 12, 2014 |
| ISO10 | NRRL B-50938 | Mar. 12, 2014 |
| ISO11 | NRRL B-50939 | Mar. 12, 2014 |
| ISO12 | NRRL B-50940 | Mar. 12, 2014 |
| ISO13 | NRRL B-50941 | Mar. 12, 2014 |
| ISO14 | NRRL B-50942 | Mar. 12, 2014 |
| ISO16 | NRRL B-67340 | Nov. 18, 2016 |
| ISO17 | NRRL B-67341 | Nov. 18, 2016 |
| ISO18 | NRRL B-67741 | Dec. 20, 2018 |
| ISO19 | NRRL B-67742 | Dec. 20, 2018 |
| ISO20 | NRRL B-67743 | Dec. 20, 2018 |
| ISO21 | NRRL B-67809 | Jun. 28, 2019 |
| ISO22 | NRRL B-67925 | Feb. 21, 2020 |
| ISO23 | NRRL B-67926 | Feb. 21, 2020 |
| ISO24 | NRRL B-67929 | Mar. 3, 2020 |
| ISO25 | NRRL B-67927 | Feb. 21, 2020 |
| ISO26 | NRRL B-67892 | Nov. 26, 2019 |
| ISO28 | NRRL B-68032 | May 20, 2021 |
| ISO29 | NRRL B-68033 | May 20, 2021 |
| ISO30 | NRRL B-68034 | May 20, 2021 |

¹ Deposit number for strain deposited with the AGRICULTURAL RESEARCH SERVICE CULTURE COLLECTION (NRRL) of the National Center for Agricultural Utilization Research, Agricultural Research Service, U.S. Department of Agriculture, 1815 North University Street, Peoria, Illinois 61604 U.S.A. under the terms of the Budapest Treaty on the International Recognition of the Deposit of Microorganisms for the Purposes of Patent Procedure. Subject to 37 CFR §1.808(b), all restrictions imposed by the depositor on the availability to the public of the deposited material will be irrevocably removed upon the granting of any patent from this patent application.

In certain embodiments of any of the aforementioned compositions, uses thereof, or methods related thereto, the Methylobacterium is adhered to a solid substance. In certain embodiments of the methods, the Methylobacterium adhered to the solid substance is provided by culturing the Methylobacterium in the presence of the solid substance. In certain embodiments of the methods, the composition is a liquid oil dispersion with Methylobacterium dispersed in an esterified seed oil. In certain embodiments, the liquid oil dispersion is emulsifiable. In certain embodiments of the methods, the composition comprises an emulsion comprising the Methylobacterium liquid oil dispersion and an aqueous continuous phase. In certain embodiments, the aqueous continuous phase comprises one or more agricultural chemicals. In certain embodiments, the Methylobacterium is one or more Methylobacterium isolates selected from ISO04, deposited as NRRL B-50932, ISO10, deposited as NRRL B-50938, and ISO20, deposited as NRRL B-67743.

In some embodiments disclosed herein the microbial inoculant is added to the non-aqueous solvent (e.g., water-immiscible solvent) as a dried powder or dried particulates. Dried inoculant powders or dried inoculant particulates may be prepared by a number of methods, including, but not limited to, by spray drying, freeze drying, fluid bed drying, vacuum drying, air drying, and electrostatic spray drying. Methods of preparing electrostatic spray-dried particulates of Methylobacterium and other gram-negative bacteria are described in co-pending International Patent Application PCT/US2020/041604, filed on Jul. 10, 2020, and published as WO2021/007516A1, which is specifically incorporated herein by reference in its entirety. In various embodiments, the moisture content of the dried inoculant powders or particulates can be no greater than about 5 wt.%, no greater than about 4 wt.%, no greater than about 3 wt.%, no greater than about 2 wt.%, or no greater than about 1 wt.%. In some embodiments, the moisture content of the dried inoculant powders or particulates is from about 0.1 wt.% to about 5 wt.%, from about 0.1 wt.% to about 4 wt.%, about 0.1 wt.% to about 3 wt.%, about 0.1 wt.% to about 2 wt.%, about 0.1 wt.% to about 1 wt.%, from about 0.5 wt.% to about 5 wt.%, from about 0.5 wt.% to about 4 wt.%, about 0.5 wt.% to about 3 wt.%, about 0.5 wt.% to about 2 wt.%, about 0.5 wt.% to about 1 wt.%, from about 1 wt.% to about 5 wt.%, from about 1 wt.% to about 4 wt.%, about 1 wt.% to about 3 wt.%, or about 1 wt.% to about 2 wt.%. In some embodiments, the concentration of microbial inoculant in the dried powder or particulate compositions used to prepare liquid oil dispersions herein is from about 1 × 10⁶ to about 1 × 10¹² CFU (colony forming units) per gram. In some embodiments, the microbial inoculant is aMethylobacterium isolate present at about 1 × 10⁷ to about 1 × 10¹² CFU per gram. In some embodiments, aMethylobacterium isolate or combination of isolates is present in the dried powder or dried particulate composition at about 1 × 10⁸ to about 5 × 10¹¹ CFU per gram. In some embodiments, a Methylobacterium isolate is present in the dried powder or dried particulate composition at about 1 × 10⁹ to about 4 × 10¹⁰ CFU per gram. In some embodiments, a Methylobacterium isolate is present in the dried powder or dried particulate composition at about 6 × 10⁹ to about 2.4 × 10¹⁰ CFU per gram.

Dried microbial inoculant preparations used to prepare the disclosed non-aqueous liquid compositions comprising dispersed inoculant in a non-aqueous solvent (e.g., a water-immiscible solvent), can comprised additional components including nutrients, carriers and fillers. In some embodiments, the carrier comprises at least one component selected from the group consisting of polyvinyl acetates, polyvinyl acetate copolymers, hydrolyzed polyvinyl acetates, polyvinylpyrrolidone, polyvinylpyrrolidone-vinyl acetate copolymer, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxy methylcelluloses, hydroxypropylcelluloses, hydroxymethylpropylcelluloses, carboxymethylcelluloses, polyvinyl pyrrolidones, alginates, dextrins, maltodextrins, polysaccharides, proteins, karaya gum, jaguar gum, tragacanth gum, polysaccharide gums, mucilage, gum arabics, shellacs, vinylidene chloride polymers and copolymers, soybean-based protein polymers and copolymers, lignosulfonates, acrylic copolymers, starches, polyvinylacrylates, zeins, gelatin, chitosan, polyethylene oxide, acrylimide polymers and copolymers, polyhydroxyethyl acrylate, methylacrylimide monomers, alginate, polychloroprene, and mixtures thereof.

In some embodiments a carrier comprises a saccharide compound, such as polysaccharide or oligosaccharide, or a sugar alcohol. In some embodiments, a carrier in the dried inoculant compositions comprises a mono- di- tri or polysaccharide selected from the group consisting of maltodextrin, fructose, sucrose, glucose, trehalose, and mixtures thereof. In some embodiments, a carrier in the dried inoculant compositions comprises or further comprises an oligosaccharide selected from the group consisting of fructo-oligosaccharides, galacto-oligosaccharides, mannan-oligosaccharides, isomalto-oligosaccharides, xylo-oligosaccharides, ribo-oligosaccharides, arabino-oligosaccharides, and mixtures thereof. In further embodiments, a carrier comprises or further comprises a sugar alcohol selected from the group consisting of ethylene glycol, glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, and mixtures thereof. The carrier can be used in excess of the microbial inoculant on a weight basis. For example, the weight ratio of the carrier to the inoculant can be at least about 2:1, at least about 5:1, at least about 10:1, at least about 25:1, or at least about 50:1. In various embodiments, the weight ratio of the carrier to the inoculant is from about 5:1 to about 75:1, from about 10:1 to about 75:1, from about 25:1 to about 75:1, from about 50:1 to about 75:1, from about 5:1 to about 50:1, from about 10:1 to about 50:1, or from about 25:1 to about 50:1. In some embodiments, the dried compositions further comprises one or more fillers that assist in the drying process. In some embodiments, the solid filler is an inert solid. In some embodiments, the solid filler is a silica selected from the group consisting of halloysite, kaolinites, montmorillonite, talc, kyanite, sillimanite, andalusite, analcime, chabazite, clinoptilolite, heulandite, natrolite, phillipsite, stillbite, fumed silicas, precipitated silicas and micas. In some embodiments, the presence of the solid filler improves the physical properties of the dried microbial powders and particulates. In some embodiments, the microbial inoculant in dried powder or dried particulate form used in the disclosed compositions is one or more Methylobacterium isolates. In certain embodiments, the Methylobacterium is one or more Methylobacterium isolates selected from ISO04, deposited as NRRL B-50932, ISO10, deposited as NRRL B-50938, and ISO20, deposited as NRRL B-67743. In some embodiments, aMethylobacterium isolate or combination of isolates is provided as particulates that are encapsulated or partially encapsulated in a carrier in an electrospray process. In some embodiments, the carrier is maltodextrin. In various embodiments, encapsulated Methylobacterium particulates are characterized by a particle size distribution where at least about 70%, at least about 80%, or at least about 90% of the particulates have a particle size (i.e., diameter of longest dimension) from about 2 microns to about 250 microns. In some embodiments, encapsulated Methylobacterium particulates can be prepared that are characterized by an average particle size of from about 1 micron to about 500 microns. Agricultural microbial inoculants, including additional components in the dried powder or dried particulate compositions comprise from about 1% to about 60% percent of the total non-aqueous liquid dispersion composition by weight.

The emulsifiable liquid inoculant compositions provided herein comprise one or more microbial inoculants dispersed in a non-aqueous solvent (e.g., a water-immiscible solvent) which forms a non-aqueous liquid phase. Such compositions can be combined with aqueous compositions comprising one or more agricultural chemicals to provide an emulsion for treatment of plants, plant parts, or soil or nutrient medium where a plant is grown. The microbial inoculants of the present invention are incorporated into said emulsions as dispersed powders or particulates in a non-aqueous phase and are protected from potential detrimental effects of the chemicals or aqueous nature of the tank solution. In some embodiments, an agricultural chemical in the aqueous composition is a fertilizer, a pesticide, a herbicide, or combinations thereof.

In certain embodiments, the fertilizer can be a single nutrient nitrogen fertilizer, such as urea, ammonia or ammonia solutions (including ammonium nitrate, ammonium sulfate, calcium ammonium nitrate, and urea ammonium nitrate). In certain embodiments, the fertilizer can be a single nutrient phosphate fertilizer, such as a superphosphate or triple superphosphate or mixtures thereof, including double superphosphate. In certain embodiments, the fertilizer can be a single nutrient potassium-based fertilizer, such as muriate of potash. In certain embodiments, the compositions comprise multinutrient fertilizers including binary fertilizers (NP, NK, PK), including, for example monoammonium phosphate, diammonium phosphate, potassium nitrate and potassium chloride. In further embodiments, three-component fertilizers (NPK) providing nitrogen, phosphorus, and potassium are present in the aqueous compositions. In still further embodiments, the fertilizer comprises micronutrients, which may be chelated or non-chelated. In some embodiments, combinations of various fertilizers can be present in the aqueous solution, including combinations of nitrogen, phosphorus and/or micronutrient fertilizers.

In certain embodiments, the pesticide can be an insecticide, a fungicide, an herbicide, a nematicide or other biocide. Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In particular embodiments insecticides and nematicides include abamectin, aldicarb, aldoxycarb, bifenthrin, carbofuran, chlorantraniliporle, chlothianidin, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, tioxazafen, spinetoram, spinosad, spirodichlofen, spirotetramat, tefluthrin, thiacloprid, thiamethoxam, and thiodicarb. Non-limiting examples of useful fungicides include aromatic hydrocarbons, benzimidazoles, benzthiadiazole, carboxamides, carboxylic acid amides, morpholines, phenylamides, phosphonates, quinone outside inhibitors (e.g., strobilurins), thiazolidines, thiophanates, thiophene carboxamides, and triazoles. Particular examples of fungicides include acibenzolar-S-methyl, azoxystrobin, benalaxyl, bixafen, boscalid, carbendazim, cyproconazole, dimethomorph, epoxiconazole, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thifluzamide, thiophanate, tolclofos-methyl, trifloxystrobin, and triticonazole. Non-limiting examples of other biocides, include isothiazolinones, for example 1,2 Benzothiazolin-3-one (BIT), 5-Chloro-2-methyl-4-isothiazolin-3-one (CIT), 2-Methyl-4-isothiazolin-3-one (MIT), octylisothiazolinone (OIT), dichlorooctylisothiazolinone (DCOIT), and butylbenzisothiazolinone (BBIT); 2-Bromo-2-nitro-propane-1,3-diol (Bronopol), 5-bromo-5-nitro-1,3-dioxane (Bronidox), Tris(hydroxymethyl)nitromethane, 2,2-Dibromo-3-nitrilopropionamide (DBNPA), and alkyl dimethyl benzyl ammonium chlorides.

Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins. Particular examples of herbicides include acetochlor, clethodim, dicamba, flumioxazin, fomesafen, glyphosate, glufosinate, mesotrione, quizalofop, saflufenacil, sulcotrione, and 2,4-D.

In some embodiments, the disclosed emulsions comprise combinations of fertilizers, pesticides and/or herbicides, including combinations of two or more pesticides, two or more fertilizers, two or more herbicides, and combinations of two or more chemicals from different classes, i.e. fertilizers, pesticides and herbicides.

### Methods of Making Microbial Inoculant Compositions

Methods of making stable microbial inoculant compositions are also provided herein. In one embodiment, a liquid composition comprising a non-aqueous solvent (e.g., a water-immiscible solvent) comprising one or more rheology modifiers and one or more emulsifiers is prepared. In some embodiments the non-aqueous solvent (e.g., water-immiscible solvent) is an esterified plant oil. Such liquid oil dispersion compositions can be prepared in a number of ways known in the art. In one embodiment, hydrophobic silica is incorporated into methyl soy oil through high shear mixing or ball milling. Emulsifiers, such as seed oil ethoxylates and ethoxylated sorbitan fatty esters are then incorporated, for example through high shear mixing. A dried microbial inoculant in the form of powder or particulates as described herein is then incorporated into said liquid composition, and dispersed to produce an emulsifiable inoculant composition. In some embodiments, the rheology modifier is a hydrophobic silica or an organoclay and the microbial inoculant is homogeneously dispersed in the non-aqueous liquid composition through low sheer mixing. In some embodiments, a rheology modifier is added in sufficient amount to comprise from about 0.1 to about 5% of the total composition by weight. Such compositions, once prepared, are stored at room temperature for future use in non-reactive containers, for example made from HDPE plastic, with limited headspace. In some embodiments, such compositions are stable for up to one year with titer losses of one log or less when stored in this manner.

In some embodiments, such methods comprise the additional step of incorporating a liquid oil dispersion composition comprising one or more agricultural inoculants into an aqueous composition comprising at least one agricultural chemical. Due to the presence of the emulsifiers in the non-aqueous dispersed microbial inoculant compositions, an emulsion is formed with an aqueous continuous phase comprising one or more agricultural chemicals and the non-aqueous liquid composition comprising dispersed microbial inoculant. In some embodiments, the dispersed microbial inoculant is one or more Methylobacterium isolates. In such embodiments, the Methylobacterium isolate(s) are stabilized from harmful effects of water and/or agricultural chemicals in the compositions by physical separation from such in the non-aqueous phase of the emulsion. In certain embodiments, the Methylobacterium is one or more Methylobacterium isolates selected from ISO04, deposited as NRRL B-50932, ISO10, deposited as NRRL B-50938, and ISO20, deposited as NRRL B-67743.

### Methods of Treating Plants and Treated Plants and Plant PARTS

Also provided are methods for treating a plant by applying microbial inoculant compositions provided herein to a plant or a plant part, to soil where a plant is grown, to a nutrient solution in which a plant is grown, for example in hydroponic growing systems, to soil where a plant part such as a seed is deposited, in aeroponic applications, such as in a root mist, or any combinations thereof. Treatments or applications can include, but are not limited to, spraying, coating, partially coating, immersing, and/or imbibing the plant or plant parts with the compositions provided herein. In certain embodiments, a seed, a leaf, a vegetative cutting, a fruit, a stem, a root, a tuber, or a coleoptile can be immersed, dipped in, and/or imbibed with a liquid, semi-liquid, emulsion, or slurry of a composition provided herein. In some embodiments, the microbial inoculant compositions comprise liquid oil dispersion compositions. In some embodiments, the microbial inoculant compositions comprise an emulsion wherein microbial inoculant is dispersed in a non-aqueous solvent (e.g., a water-immiscible solvent) and one or more agricultural chemicals are present in an aqueous continuous phase. Such liquid oil dispersion or emulsions compositions comprising microbial inoculant can be applied to plant seeds directly, for example by mixing in a planter box, by in-furrow application, or may be applied as foliar sprays. Plants and plant parts coated or partially coated with the microbial inoculant compositions are also provided herein.

In certain embodiments of the methods, the plant part is selected from the group consisting of a leaf, a stem, a fruit, a vegetative cutting, a flower, a root, a seedling, a tuber, or a seed. In certain embodiments of the methods, the method further comprises the step of harvesting at least one plant part selected from the treated plant or plant grown from the treated plant part. In certain embodiments of the aforementioned methods, the method further comprises obtaining a processed food or feed composition from the plant or plant part. In certain embodiments, the microbial inoculant is a Methylobacterium isolate, and the amount of Methylobacterium applied to a plant or plant part (e.g., a seed) is about 1 ×10², 1 × 10³, 1 × 10⁴, or 1 × 10⁵ to about 1 × 10⁷, 1 × 10⁸, 1 × 10⁹, or 1 × 10¹⁰ CFUs ofMethylobacterium per plant or plant part (e.g., a seed). In certain embodiments, the Methylobacterium is heterologous to the plant or plant part. In certain embodiments of any of the aforementioned methods, the plant part is a leaf, a stem, a fruit, a vegetative cutting, a flower, a root, a seedling, a tuber, or a seed.

In certain embodiments of any of the foregoing methods, the plant is corn, soybean, Brassica sp. (e.g., B. napus, B. rapa, B. juncea), alfalfa, rice, rye, wheat, barley, oats, sorghum, millet (e.g., pearl millet (Pennisetum glaucum)), proso millet (Panicum miliaceum), foxtail millet (Setaria italica), finger millet (Eleusine coracana), sunflower, safflower, tobacco, potato, peanuts, cotton, species in the genus Cannabis (including, but not limited to, Cannabis sativa and industrial hemp varieties), sweet potato (Ipomoea batatus), cassava, coffee, coconut, pineapple, citrus trees, cocoa, tea, date palm, banana, apple, pear, grape, berry plants (including, but not limited to blackberry, raspberry, strawberry or blueberry plants), avocado, fig, guava, kiwi, mango, olive, papaya, cashew, macadamia, almond, sugar beets, sugarcane, tomatoes, peppers, lettuce, leafy greens (including, but not limited to, spinach, kale, microgreens, collard greens, cabbage, beet greens, watercress, romaine lettuce, swiss chard, arugula, endive, bok choy and turnip greens), green beans, lima beans, peas, lentils, cucurbits (including, but not limited to cucumber, cantaloupe, melons, squash, pumpkin, and zucchini). In other embodiments, treated plants include ornamentals (including, but not limited to, azalea, hydrangea, hibiscus, roses, tulips, daffodils, petunias, carnation, poinsettia, and chrysanthemum), conifers (including, but not limited to pines such as loblolly pine, slash pine, ponderosa pine, lodge pole pine, and Monterey pine; Douglas-fir; Western hemlock; Sitka spruce; redwood; true firs such as silver fir and balsam fir; and cedars such as Western red cedar and Alaska yellow-cedar) and turfgrass (including, but are not limited to, annual bluegrass, annual ryegrass, Canada bluegrass, fescue, bentgrass, wheatgrass, Kentucky bluegrass, orchard grass, ryegrass, redtop, Bermuda grass, St. Augustine grass, and zoysia grass).

In certain embodiments, the inoculant is one or more Methylobacterium isolates selected from ISO04, deposited as NRRL B-50932, ISO10, deposited as NRRL B-50938, and ISO20, deposited as NRRL B-67743, the plant is corn or soybean, and the inoculant is applied to the seed.

In certain embodiments of any of the foregoing compositions and methods, microbial inoculant compositions are provided which comprise Methylobacterium at a titer of greater than about 5 × 10⁷ colony-forming units per milliliter, at a titer of greater than about 1 × 10⁸ colony-forming units per milliliter, at a titer of greater than about 5 × 10⁸ colony-forming units per milliliter, at a titer of greater than about 1 × 10⁹ colony-forming units per milliliter, at a titer of greater than about 1 × 10¹⁰ colony-forming units per milliliter, at a titer of at least about 3 × 10¹⁰ colony-forming units per milliliter. In certain embodiments, microbial inoculant compositions provided herein comprise Methylobacterium at a titer of at least about 5 × 10⁷, 1 × 10⁸, or 5 × 10⁸ colony-forming units per milliliter to at least about 4 × 10¹⁰ colony-forming units per milliliter, at least about 5 × 10⁸ colony-forming units per milliliter to at least about 4 × 10¹⁰ colony-forming units per milliliter, or at least about 5 × 10⁸ colony-forming units per milliliter to at least about 6 × 10¹⁰ colony-forming units per milliliter. In certain embodiments, microbial inoculant compositions provided herein comprise Methylobacterium at a titer of at least about 1 × 10⁹ colony-forming units per milliliter to at least about 3 × 10¹⁰ colony-forming units per milliliter, at least about 1 × 10⁹ colony-forming units per milliliter to at least about 4 × 10¹⁰ colony-forming units per milliliter, or at least about 1 × 10⁹ colony-forming units per milliliter to at least about 6 × 10¹⁰ colony-forming units per milliliter. In certain embodiments, microbial inoculant compositions provided herein comprise Methylobacterium at a titer of at least about 1 × 10¹⁰ colony-forming units per milliliter to at least about 3 × 10¹⁰ colony-forming units per milliliter, at least about 1 × 10¹⁰ colony-forming units per milliliter to at least about 4 × 10¹⁰ colony-forming units per milliliter, or at least about 1 × 10¹⁰ colony-forming units per milliliter to at least about 6 × 10¹⁰ colony-forming units per milliliter. In certain embodiments, microbial inoculant compositions provided herein comprise Methylobacterium at a titer of, at least about 3 × 10¹⁰ colony-forming units per milliliter to at least about 4 × 10¹⁰ colony-forming units per milliliter, or at least about 3 × 10¹⁰ colony-forming units per milliliter to at least about 6 × 10¹⁰ colony-forming units per milliliter. In any of the aforementioned compositions, the compositions can be essentially free of contaminating microorganisms, can comprise Methylobacterium that are adhered to and/or associated with materials that the Methylobacterium are not are adhered to and/or associated with in nature, or any combination thereof.

In certain embodiments of any of the foregoing compositions and methods, dried preparations or microbial inoculant compositions with Methylobacterium at a titer of greater than about 5 × 10⁷, 1 × 10⁸, or 5 × 10⁸ colony-forming units per gram, at a titer of greater than about 1 × 10⁹ colony-forming units per gram, at a titer of greater than about 1 × 10¹⁰ colony-forming units per gram, at a titer of at least about 3 × 10¹⁰ colony-forming units per gram are provided. In certain embodiments, microbial inoculant compositions provided herein comprise Methylobacterium at a titer of at least about 5 × 10⁷, 1 × 10⁸, or 5 × 10⁸ colony-forming units per gram to at least about 3 × 10¹⁰ colony-forming units per gram, at least about 5 × 10⁷, 1 × 10⁸, or 5 × 10⁸ colony-forming units per gram to at least about 4 × 10¹⁰ colony-forming units per gram, or at least about 5 × 10⁷, 1 × 10⁸, or 5 × 10⁸ colony-forming units per gram to at least about 6 × 10¹⁰ colony-forming units per gram. In certain embodiments, microbial inoculant compositions provided herein can comprise Methylobacterium at a titer of at least about 1 × 10⁹ colony-forming units per gram to at least about 3 × 10¹⁰ colony-forming units per gram, at least about 1 × 10⁹ colony-forming units per gram to at least about 4 × 10¹⁰ colony-forming units per gram, or at least about 1 × 10⁹ colony-forming units per gram to at least about 6 × 10¹⁰ colony-forming units per gram. In certain embodiments, microbial inoculant compositions provided herein will comprise Methylobacterium at a titer of at least about 1 × 10¹⁰ colony-forming units per gram to at least about 3 × 10¹⁰ colony-forming units per gram, at least about 1 × 10¹⁰ colony-forming units per gram to at least about 4 × 10¹⁰ colony-forming units per gram, or at least about 1 × 10¹⁰ colony-forming units per gram to at least about 6 × 10¹⁰ colony-forming units per gram. In certain embodiments, microbial inoculant compositions provided herein will comprise Methylobacterium at a titer of, at least about 3 × 10¹⁰ colony-forming units per gram to at least about 4 × 10¹⁰ colony-forming units per gram, or at least about 3 × 10¹⁰ colony-forming units per gram to at least about 6 × 10¹⁰, 1 × 10¹¹, 1 × 10¹², 1×10¹³, or 5×10¹³ colony-forming units per gram. In any of the aforementioned microbial inoculant or compositions, the composition can comprise Methylobacterium that is adhered to a solid substance. In any of the aforementioned microbial inoculant compositions, the compositions can be essentially free of contaminating microorganisms, can comprise Methylobacterium that are adhered to and/or associated with materials that the Methylobacterium are not are adhered to and/or associated with in nature, or any combination thereof. In certain embodiments, the Methylobacterium is one or more Methylobacterium isolates selected from ISO04, deposited as NRRL B-50932, ISO10, deposited as NRRL B-50938, and ISO20, deposited as NRRL B-67743.

In some embodiments, the compositions or methods disclosed herein may comprise one or more Methylobacterium isolates and an additional active ingredient selected from the group consisting of clothianidin, ipconazole, imidacloprid, metalaxyl, mefenoxam, tioxazafen, azoxystrobin, thiamethoxam, fluopyram, prothioconazole, pyraclostrobin, and sedaxane.

In some embodiments, the compositions or methods disclosed herein may comprise one or more Methylobacterium isolates and an additional active ingredient, which may be a second biological. The second biological could be a biological control agent, other beneficial microorganisms, microbial extracts, natural products, plant growth activators or plant defense agent. Non-limiting examples of the second biological could include bacteria, fungi, beneficial nematodes, and viruses. Such additional biologicals or active ingredients may be added to liquid oil dispersion compositions described herein or may be present in or added to the aqueous tank compositions in aqueous form, as soluble powders, or in a second liquid oil dispersion composition, separate from that comprising dispersed Methylobacterium.

In certain embodiments, the second biological can be a bacterium of the genus Actinomycetes, Agrobacterium, Arthrobacter, Alcaligenes, Aureobacterium, Azobacter, Azorhizobium, Azospirillum, Azotobacter, Beijerinckia, Bacillus, Brevibacillus, Burkholderia, Chromobacterium, Clostridium, Clavibacter, Comomonas, Corynebacterium, Curtobacterium, Enterobacter, Flavobacterium, Gluconacetobacter, Gluconobacter, Herbaspirillum, Hydrogenophage, Klebsiella, Luteibacter, Lysinibacillus, Mesorhizobium, Methylobacterium, Microbacterium, Ochrobactrum, Paenibacillus, Pantoea, Pasteuria, Phingobacterium, Photorhabdus, Phyllobacterium, Pseudomonas, Rhizobium, Rhodococcus, Bradyrhizobium, Serratia, Sinorhizobium, Sphingomonas, Streptomyces, Stenotrophomonas, Variovorax, Xanthomonas and Xenorhadbus. In particular embodiments, the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomona fluorescens.

In certain embodiments the second biological can be a fungus of the genus Acremonium, Alternaria, Ampelomyces, Aspergillus, Aureobasidium, Beauveria, Botryosphaeria, Cladosporium, Cochliobolus, Colletotrichum, Coniothyrium, Embellisia, Epicoccum, Fusarium, Gigaspora, Gliocladium, Glomus, Laccaria, Metarhisium, Muscodor, Nigrospora, Paecilonyces, Paraglomus, Penicillium, Phoma, Pisolithus, Podospora, Rhizopogon, Scleroderma, Trichoderma, Typhula, Ulocladium, and Verticilium. In particular embodiments, the fungus is Beauveria bassiana, Coniothyrium minitans, Gliocladium vixens, Muscodor albus, Paecilomyces lilacinus, or Trichoderma polysporum.

In further embodiments the second biological can be plant growth activators or plant defense agents including, but not limited to harpin, Reynoutria sachalinensis, jasmonate, lipochitooligosaccharides, and isoflavones.

In further embodiments, the second biological can include, but is not limited to, various Bacillus sp., Pseudomonas sp., Coniothyrium sp., Pantoea sp., Streptomyces sp., and Trichoderma sp. Microbial biopesticides can be a bacterium, fungus, virus, or protozoan. Particularly useful biopesticidal microorganisms include various Bacillus subtilis, Bacillus thuringiensis, Bacillus pumilis, Pseudomonas syringae, Trichoderma harzianum, Trichoderma virens, and Streptomyces lydicus strains. Other microorganisms that are added can be genetically engineered or wild-type isolates that are available as pure cultures. In certain embodiments, it is anticipated that the second biological can be provided in the composition in the form of a spore.

In further embodiments of any of the foregoing compositions or methods, additional components may include agricultural excipients and/or agricultural adjuvants. Agriculturally acceptable adjuvants used in the compositions include, but are not limited to, components that enhance product efficacy and/or products that enhance ease of product application. Adjuvants that enhance product efficacy can include various wetters/spreaders that promote adhesion to and spreading of the composition on plant parts, stickers that promote adhesion to the plant part, penetrants that can promote contact of the active agent with interior tissues, extenders that increase the half-life of the active agent by inhibiting environmental degradation, and humectants that increase the density or drying time of sprayed compositions. Wetters/spreaders used in the compositions can include, but are not limited to, non- ionic surfactants, including, but not limited to alkylpolyglucosides (APGs), polysorbate/sorbitan based surfactants (e.g.Tween/Span), fatty alcohol ethoxylates, fatty acid ethoxylates, alkylphenol ethoxylates, fatty glycerol esters, block copolymers (e.g., Poloxamers); anionic surfactants; cationic surfactants; amphoteric surfactants, such as phospholipids (including but not limited to phosphatidylserine, phosphatidylethanolamine, phosphatidylcholine, and sphingomyelins) cocamidoporpyl based surfactants (including but not limited to betaines and sultaines); organo-silicate surfactant wetting agents (including but not limited to trisiloxane, and polyether siloxanec); and/or acidified surfactants. Stickers used in the compositions can include, but are not limited to, film forming substances, such as calcium alginate or other mineral alginates, gelatin, drying oils (such as tung oil and linseed oil), and polyvinyl alcohols/acrylates; latex-based substances, terpene/pinolene, and pyrrolidone-based substances. Penetrants can include mineral oil, vegetable oil, esterified vegetable oil, organo-silicate surfactants, and acidified surfactants. Extenders used in the compositions can include, but are not limited to, ammonium sulphate, or menthene-based substances. Humectants used in the compositions can include, but are not limited to, glycerol, propylene glycol, and diethyl glycol. Adjuvants that improve ease of product application include, but are not limited to, dispersants, acidifying/buffering agents, anti-foaming/de- foaming agents, compatibility agents, drift-reducing agents, dyes, and water conditioners. Dispersants that improve ease of use and handling for homogenous mixing and application of product include, for example, acrylate polymers or copolymers, lignosulfonates, (alkyl)naphthalene sulfonate. Antifoaming/de- foaming agents used in the compositions can include, but are not limited to, dimethopolysiloxane. Compatibility agents used in the compositions can include, but are not limited to, ammonium sulphate. Drift-reducing agents used in the compositions can include, but are not limited to, polyacrylamides, and polysaccharides. Water conditioners used in the compositions can include, but are not limited to, ammonium sulphate.

In certain embodiments, the microbial inoculant compositions used to treat a plant or plant seed can contain agriculturally acceptable excipients in addition to those used in preparation of the oil dispersion compositions. Such excipients include, but are not limited to, woodflours, clays, activated carbon, diatomaceous earth, fine-grain inorganic solids, calcium carbonate and the like. Clays and inorganic solids that can be used with the compositions provided herein include, but are not limited to, calcium bentonite, kaolin, china clay, talc, graphite, perlite, mica, vermiculite, silicas, quartz powder, montmorillonite and mixtures thereof. In certain embodiments where plant seeds are treated with microbial inoculant compositions provided herein, the compositions further comprise one or more lubricants to ensure smooth flow and separation (singulation) of seeds in the seeding mechanism, for example a planter box. Lubricants for use in such compositions include talc, graphite, polyethylene wax-based powders (such as Fluency Agent), protein powders, for example soybean protein powders, or a combination of protein powders and a lipid, for example lecithin or a vegetable oil. Combinations of such lubricants may also be used, including, for example blends of clay and talc. Lubricants can be applied to seeds simultaneously with application of inoculant or may be mixed with the inoculant prior to application of the compositions to the seeds. Agriculturally acceptable adjuvants that promote sticking to the seed that can be used include, but are not limited to, polyvinyl acetates, polyvinyl acetate copolymers, hydrolyzed polyvinyl acetates, polyvinylpyrrolidone, polyvinylpyrrolidone-vinyl acetate copolymer, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxy methylcelluloses, hydroxypropylcellulose, hydroxymethylpropylcelluloses, alginates, dextrins, malto-dextrins, polysaccharides, fats, oils, proteins, karaya gum, jaguar gum, tragacanth gum, polysaccharide gums, mucilage, gum arables, shellacs, vinylidene chloride polymers and copolymers, soybean-based protein polymers and copolymers, lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof. Other useful agriculturally acceptable adjuvants that can promote coating include, but are not limited to, polymers and copolymers of vinyl acetate, polyvinylpyrrolidone- vinyl acetate copolymer and water-soluble waxes. Various surfactants, dispersants, anticaking-agents, foam-control agents, and dyes disclosed herein and in U.S. Pat. No. 8,181,388 can be adapted for use in compositions provided herein.

Having described the embodiments in detail, it will be apparent that modifications and variations are possible without departing from the scope defined in the appended claims.

### EXAMPLES

Various liquid oil dispersion compositions comprising Methylobacterium isolates are provided below.

Composition 1

| Material | Material Type | Purpose | WT% |
|---|---|---|---|
| Steposol SB-W | Esterified soybean seed oil | Continuous phase | 61.6 |
| Aerosil R972 | Hydrophobic silica | Rheology modifier | 1.4 |
| Toximul 8240 | Castor oil ethoxylate | Emulsifier | 6.3 |
| Tween 80 | Ethoxylated sorbitan fatty ester | Emulsifier | 0.7 |
| Spray Dried Powder | Methylobacterium | Microbial inoculant | 30 |

Composition 2

| Material | Material Type | Purpose | WT% |
|---|---|---|---|
| Steposol SB-W | Esterified soybean seed oil | Continuous phase | 50.4 |
| Atlox 4915 | Amphoteric polymer based surfactant | Emulsifier | 3 |
| Aerosil R972 | Hydrophobic silica | Rheology modifier | 0.6 |
| Toximul 8240 | Castor oil ethoxylate | Emulsifier | 5.4 |
| Tween 80 | Ethoxylated sorbitan fatty ester | Emulsifier | 0.6 |
| Spray Dried Powder | Methylobacterium | Microbial inoculant | 40 |

Composition 3

| Material | Material Type | Purpose | WT% |
|---|---|---|---|
| Steposol SB-W | Esterified soybean seed oil | Continuous phase | 52.1 |
| Bentone SD-1 | Organoclay | Oil rheology modifier | 1.6 |
| Toximul 8240 | Castor oil ethoxylate | Emulsifier | 5.4 |
| Tween 80 | Ethoxylated sorbitan fatty ester | Emulsifier | 0.6 |
| Kelco-Vis DG | Diutan gum | Stabilizer (Aqueous Rheology modifier) | 0.3 |
| Spray Dried Powder | Methylobacterium | Microbial inoculant | 40 |

Composition 4

| Material | Material Type | Purpose | WT% |
|---|---|---|---|
| Steposol SB-W | Esterified soybean seed oil | Continuous phase | 69.5 |
| Bentone SD-1 | Organoclay | Oil rheology modifier | 2.1 |
| Toximul 8240 | Castor oil ethoxylate | Emulsifier | 7.2 |
| Tween 80 | Ethoxylated sorbitan fatty ester | Emulsifier | 0.8 |
| Kelco-Vis DG | Diutan gum | Stabilizer (Aqueous Rheology modifier) | 0.4 |
| Spray Dried Powder | Methylobacterium | Microbial inoculant | 20 |

Observation of the compositions after storage at 54° C. indicates that little to no settling of dispersed inoculant occurred after 2 weeks.

Stability of Composition 2 was evaluated at 54° C. after 0, 1, and 2 weeks storage and recorded as 4.18 × 10¹⁰ CFU/ml at 0 weeks, 3.24 × 10⁹ CFU/ml at 1 week, and 5 × 10⁷ CFU/ml at 2 weeks. Stability under these accelerated storage stability conditions predicts a stability of 1 year at room temperature for a 1 log loss in titer. Results are similar to those obtained with spray-dried powder inoculant stored under the same conditions. Dried powder inoculant titers were 5.68 × 10¹⁰ CFU/gm at 0 weeks, 1.78 × 10⁹ CFU/gm at 1 week, and 7 × 10⁷ CFU/gm at 2 weeks.

ADDITIONAL COMPOSITIONS

| | 1A | | 2A | | |
|---|---|---|---|---|---|
| Material | Mass | WT% | Mass | WT% | Purpose |
| Spray dried powder | 20 | 29% | 20 | 29% | Methylobacterium inoculant |
| Steposol SB-W | 44.25 | 63.3% | 44.25 | 63.3% | Continuous phase |
| Toximul 8240 | 4.5 | 6% | 2.25 | 3% | Emulsifier |
| Tween 80 | 0.5 | 1% | 0.25 | 0% | Emulsifier |
| Decaglycan | 0 | NA | 2.5 | 4% | Emulsifier |
| Aerosil R974 | 0.5 | 0.7% | 0.5 | 0.7% | Rheology modifier |
| Kelzan DG | 0.25 | 0% | 0.25 | 0% | Stabilizer |
| Total | 70 | 100% | 70 | 100% | |
| Spray dried powder | 20 | 29% | 20 | 29% | Methylobacterium inoculant |
| Steposol SB-W | 44.6 | 63.5% | 44.6 | 63.5% | Continuous phase |
| Toximul 8240 | 4.5 | 6% | 2.25 | 3% | Emulsifier |
| Tween 80 | 0.5 | 1% | 0.25 | 0% | Emulsifier |
| Decaglycan | 0 | NA | 2.5 | 4% | Emulsifier |
| Aerosil R974 | 0.4 | 0.5% | 0.4 | 0.5% | Rheology modifier |
| Kelzan DG | 0.25 | 0% | 0.25 | 0% | Stabilizer |
| Total | 70.25 | 100% | 70.25 | 100% | |

Observation of the compositions after storage at 54° C. indicates little or no settling of dispersed inoculant after 1 week. Composition 1A ranked highest in physical stability of the emulsion, followed in order by Composition 1B, 2A and 2B.

Tank stability of the compositions was evaluated at 54° C. after 0 and 1 week; storage and titers ranged from 1 × 10⁸ to 1× 10⁹ CFU/gm. Stability under these accelerated storage stability conditions predicts a stability of 1 year at room temperature for a 1 log loss in titer. Results are similar to those obtained with spray-dried powder inoculant stored under the same conditions.

1. A microbial inoculant composition comprising:
i) a non-aqueous continuous phase comprising a non-aqueous solvent, wherein said solvent comprises from about 15% to about 98.8% percent of the total composition by weight;
ii) a rheology modifier comprising from about 0.1% to about 5% percent of the total composition by weight;
iii) at least one emulsifier comprising from about 0.1% to about 20% percent of the total composition be weight; and
iv) at least one agricultural microbial inoculant, dispersed in said continuous phase, wherein said agricultural inoculant comprises from about 1% to about 60% percent of the total composition by weight.

2. The composition of claim 1, wherein the non-aqueous solvent comprises a water-immiscible solvent.

3. The composition of claim 2, wherein said water-immiscible solvent is an esterified plant oil.

4. The composition of claim 3, wherein said esterified plant oil is a methyl plant oil.

5. The composition of claim 3, wherein said esterified plant oil is a soybean oil.

6. The composition of claim 5, wherein said soybean oil is methyl soybean oil.

7. The composition of any one of claims 1 to 6, wherein said microbial inoculant is a Methylobacterium isolate.

8. The composition of claim 7, wherein said Methylobacterium is selected from ISO04, deposited as NRRL B-50932, ISO10, deposited as NRRL B-50938, and ISO20, deposited as NRRL B-67743.

9. The composition of claim 7 or 8, wherein said Methylobacterium isolate is at a concentration of at least about 1 × 10⁸ CFU per gm of said composition.

10. The composition of any one of claims 7 to 9, wherein said Methylobacterium isolate is at a concentration of at least about 1 × 10⁷ CFU per gm of said composition following storage for 26 weeks at room temperature.

11. The composition of any one of claims 1 to 10, wherein said rheology modifier comprises a hydrophobic silica or an organoclay.

12. The composition of any one of claims 1 to 11, wherein said composition further comprises a stabilizer.

13. The composition of claim 12, wherein said stabilizer is a xanthan gum or diutan gum.

14. The composition of any one of claims 1 to 13, wherein said emulsifier comprises a seed oil ethoxylate and/or an ethoxylated sorbitan fatty ester.

15. The composition of any one of claims 1 to 14, wherein said microbial inoculant is homogenously dispersed in said continuous phase.

16. A microbial inoculant composition comprising an emulsion, wherein said emulsion comprises the composition of any one of claims 1 to 15 and an aqueous phase comprising an agricultural chemical.

17. The composition of claim 16, wherein said agricultural chemical is selected from the group consisting of a fertilizer, a pesticide and an herbicide.

18. A method of making a stable liquid microbial inoculant composition, wherein said method comprises:
i) preparing a liquid composition comprising a non-aqueous solvent comprising one or more rheology modifiers and one or more emulsifiers;
ii) incorporating a dried inoculant composition into said liquid composition; and
iii) dispersing said dried inoculant in said liquid composition to produce an emulsifiable inoculant composition.

19. The method of claim 18, wherein the non-aqueous solvent comprises a water-immiscible solvent.

20. The method of claim 19, wherein said water-immiscible solvent is an esterified plant oil.

21. The method of any one of claims 18 to 20, wherein said inoculant is a Methylobacterium isolate.

22. The method of claim 21, wherein said Methylobacterium is selected from ISO04, deposited as NRRL B-50932, ISO10, deposited as NRRL B-50938, and ISO20, deposited as NRRL B-67743.

23. The method of claim 21 or 22, wherein said Methylobacterium is at a concentration of at least about 1 × 10⁸ CFU per gm of said composition.

24. The method of any one of claims 21 to 23, wherein said method further comprises the step of incorporating said emulsifiable inoculant composition into an aqueous composition comprising at least one agricultural chemical, whereby an emulsion comprising dispersed Methylobacterium in a water-immiscible phase and an aqueous continuous phase is produced.

25. The method of any one of claims 18 to 24, wherein said rheology modifier comprises a hydrophobic silica or an organoclay.

26. The method of any one of claims 18 to 25, wherein said emulsifier comprises a seed oil ethoxylate and/or an ethoxylated sorbitan fatty ester.

27. A plant part coated with the composition of any one of claims 1 to 17.

28. The plant part of claim 27, wherein said plant part is a seed.

29. The plant seed of claim 28, wherein said Methylobacterium is at a concentration of at least about 10³ CFU per seed after storage for 6 months at room temperature.

30. A method of treating a plant comprising applying the composition of any one of claims 1 to 17 to a plant or plant part, or to soil or a nutrient media where a plant is grown.

31. The method of claim 30, wherein said plant part is a seed.
